(19) United States
(12) Patent Application Publication
(10) Pub. No.: US 2026/0061984 A1
(43) Pub. Date: Mar. 5, 2026

(54) BRAKE SYSTEM AND METHOD FOR CONTROLLING THE SAME

(71) Applicant: HL MANDO CORPORATION, Gyeonggi-do (KR)

(72) Inventor: Minsoo KIM, Gyeonggi-do (KR)

(21) Appl. No.: 19/318,343

(22) Filed: Sep. 3, 2025

(30) Foreign Application Priority Data
Sep. 4, 2024 (KR) 10-2024-0120385
Apr. 14, 2025 (KR) 10-2025-0048144

(51) Int. Cl. B60T 17/22; B60T 13/14

(52) U.S. Cl. CPC B60T 17/222; B60T 13/147; B60T 2270/88

(57) ABSTRACT

A brake system is provided comprising a reservoir, master cylinder, hydraulic pressure supply unit, hydraulic control unit, pressure sensor, and controller. The controller identifies a filling control sequence start when a pressure detection signal rises above and maintains a predetermined first reference pressure during standby mode. Subsequently, the controller identifies air evacuation mode entry when the signal falls below a second reference pressure, and fluid filling mode entry when the signal rises again. During air evacuation mode, the controller repeatedly opens and closes hydraulic control unit valves to discharge air from fluid passages. During fluid filling mode, the controller drives the hydraulic pressure supply unit motor to supply pressure medium. This autonomous filling control system operates solely on pressure sensor signals without requiring external equipment communication, enabling self-contained brake system charging through precise pressure profile analysis and automated mode transitions.

### CROSS REFERENCE TO PARENT APPLICATIONS

This application claims the benefit of Korean Patent Application Serial No. 10-2024-0120385 filed on Sep. 4, 2024 and Korean Patent Application Serial No. 10-2025-0048144 filed on Apr. 14, 2025, in the Korean Intellectual Property Office, the disclosure of which is incorporated herein by reference.

### BACKGROUND

Various embodiments of the present disclosure relate to a brake system and a method for controlling the same, and more particularly, to a technique for charging brake fluid into a hydraulic circuit in a vehicle.

A brake system used in vehicles is configured to reduce the traveling speed of the vehicle or to temporarily stop the vehicle during operation. When the driver presses the brake pedal, the pressure applied to the brake pedal is transmitted to a brake master cylinder. When pressure is applied to the brake master cylinder, a piston in the master cylinder supplies brake fluid through a hydraulic passage. The supplied brake fluid is delivered to wheel cylinders installed on each of a plurality of wheels through the hydraulic passage, and the wheel cylinders operate to activate the brakes on each wheel.

In such brake systems, braking operations are performed after brake fluid is charged into the hydraulic passage using a fluid charging device. During the charging process, it is necessary to eliminate air inside the hydraulic passage and to fill the passage completely with brake fluid by controlling the internal fluid path of the brake actuator.

To achieve this, in addition to a vacuum depressurizing device and a brake fluid charging device, it is also necessary to provide a separate diagnostic device to monitor the condition of the hydraulic passage. However, the brake system is not equipped to monitor the progress of the fluid charging process in real time. As a result, it may be difficult to confirm whether improper operations are occurring, since the timing of issuing commands for diagnosing the passage condition and commands for depressurizing and charging may not be synchronized.

### SUMMARY

The features and advantages of the present disclosure will be more readily understood and apparent from the following detailed description, which should be read in conjunction with the accompanying drawings, and from the claims which are appended to the end of the detailed description.

According to various embodiments of the present disclosure, a brake system may comprise: a reservoir configured to store a pressure medium; a master cylinder configured to pressurize and discharge the pressure medium stored in the reservoir based on an applied force of a brake pedal; a hydraulic pressure supply unit configured to generate hydraulic pressure based on a pedal displacement signal output in response to displacement of the brake pedal; a hydraulic control unit provided between the hydraulic pressure supply unit and a plurality of wheel cylinders, and configured to control a flow of the pressure medium supplied to the plurality of wheel cylinders; at least one pressure sensor provided in a fluid passage connected to at least one of the reservoir, the master cylinder, the hydraulic pressure supply unit, and the hydraulic control unit, and configured to detect a hydraulic pressure of the pressure medium and output a pressure detection signal; and a controller configured to control the hydraulic pressure supply unit and the hydraulic control unit, wherein the controller is configured to: identify a start of a filling control sequence related to the pressure medium based on the pressure detection signal rising above and being maintained at a predetermined first reference pressure during a standby mode, identify entry into an air evacuation mode based on the variation of the pressure detection signal falling below a predetermined second reference pressure after identifying the start of the filling control sequence, identify entry into a fluid filling mode based on the variation of the pressure detection signal rising again during the air evacuation mode, and control valves of the hydraulic control unit to repeatedly open and close during the air evacuation mode; and control a motor of the hydraulic pressure supply unit and the hydraulic control unit based on a predetermined control pattern in at least one of the first and second operation modes to supply the pressure medium during fluid filling mode.

The first reference pressure may be set based on at least one of calibration of the pressure sensor, a baseline pressure of the fluid passage, or a detection margin associated with the pressure detection signal.

The controller may be configured to drive the motor of the hydraulic pressure supply unit based on a predetermined timing signal during the air evacuation mode while controlling operation of valves of the hydraulic control unit to discharge air from the fluid passage.

The controller may be configured to drive the motor of the hydraulic pressure supply unit based on a predetermined timing signal during the fluid filling mode while controlling operation of valves of the hydraulic control unit to fill the fluid passage with the pressure medium.

The controller may be configured to identify entry into a fluid level adjustment mode based on the pressure detection signal reaching the second reference pressure during the fluid filling mode, and control the hydraulic pressure supply unit to adjust a fluid level of the pressure medium stored in the reservoir during the fluid level adjustment mode.

The controller may be configured to repeatedly perform a sequence comprising the air evacuation mode and the fluid filling mode for a predetermined number of times, and set different maintenance times for the fluid filling mode during repetition of the sequence.

The controller may be configured to measure a detection time during which the pressure detection signal satisfies the first reference pressure, compare the measured detection time with a maintenance reference time, and identify the start of the filling control sequence based on the result of the comparison.

The controller may be configured to set the maintenance reference time based on a sensitivity of the pressure sensor to recognize the start of the filling control sequence.

The second reference pressure may be set to a sensed pressure detected from the pressure detection signal during the standby mode.

The timing signal may comprise control timing configured to control at least one of the motor of the hydraulic pressure supply unit and valves of the hydraulic control unit to discharge air from the fluid passage.

The timing signal may comprise control timing configured to control at least one of the motor of the hydraulic pressure supply unit and valves of the hydraulic control unit to fill the fluid passage with the pressure medium.

According to some embodiments of the present disclosure, a control method for a brake system comprising a reservoir configured to store a pressure medium, a master cylinder configured to pressurize and discharge the pressure medium, a hydraulic pressure supply unit configured to generate hydraulic pressure, a hydraulic control unit configured to control the flow of the pressure medium, at least one pressure sensor provided in a fluid passage connected to at least one of the foregoing components and configured to detect a hydraulic pressure of the pressure medium and output a pressure detection signal, and a controller configured to control the hydraulic pressure supply unit and the hydraulic control unit, the method comprising: identifying, by the controller, a start of a filling control sequence related to the pressure medium based on the pressure detection signal rising above and being maintained at a predetermined first reference pressure during a standby mode; identifying entry into an air evacuation mode based on the pressure detection signal falling below a predetermined second reference pressure after identifying the start of the filling control sequence; identifying entry into a fluid filling mode based on the pressure detection signal rising again during the air evacuation mode; and controlling valves of the hydraulic control unit to repeatedly open and close during the air evacuation mode, and controlling a motor of the hydraulic pressure supply unit to supply the pressure medium during the fluid filling mode.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1 shows a diagram illustrating a pressure medium charging apparatus for charging a pressure medium into a brake system, according to one or more exemplary embodiments of the present disclosure.

FIG. 2 illustrates a configuration of a vehicle including a brake system according to one or more exemplary embodiments of the present disclosure.

FIG. 3 illustrates a structural configuration of a hydraulic pressure supply module included in the brake system according to one or more exemplary embodiments of the present disclosure.

FIG. 4 illustrates a filling control sequence of the brake system according to one or more exemplary embodiments of the present disclosure.

FIG. 5 shows another example of the brake system according to one or more exemplary embodiments of the present disclosure.

FIG. 6 illustrates a method for controlling the brake system according to one or more exemplary embodiments of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

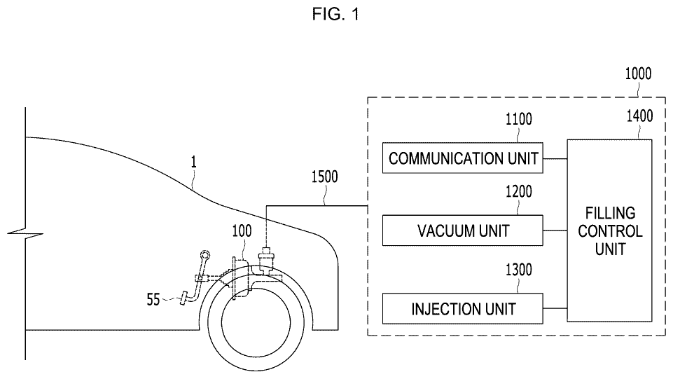

Referring to FIG. 1, a vehicle 1 may be charged with a pressure medium (e.g., brake fluid) into a brake system 100 by a pressure medium charging apparatus 1000.

The pressure medium charging apparatus 1000 may include a communication unit 1100, a vacuum unit 1200, an injection unit 1300, a filling control unit 1400, and a filling gun 1500. These components are not necessarily essential, and all or some of them may be omitted in certain embodiments.

The communication unit 1100 may communicate with the vehicle 1 to identify the vehicle for the purpose of charging the pressure medium.

The vacuum unit 1200 may perform vacuum suction using a vacuum pump (not shown) until a fluid passage of the brake system 100 of the vehicle 1 reaches a predetermined vacuum level. The vacuum unit 1200 may also recover a predetermined amount of pressure medium after filling in order to adjust the fluid level in the brake system 100.

The injection unit 1300 may supply the pressure medium stored in a pressure medium reservoir tank (not shown) to the filling gun 1500 by using an injection pump (not shown). The injection unit 1300 may inject the pressure medium into the brake system 100 of the vehicle 1 via the filling gun 1500.

The filling control unit 1400 may control the communication unit 1100, the vacuum unit 1200, and the injection unit 1300 so as to fill the brake system 100 of the vehicle 1 with the pressure medium. The filling control unit 1400 may include a processor, a memory storing programs and data for operating the pressure medium charging apparatus 1000, and optionally a programmable logic controller (PLC) and/or control circuitry. For example, the filling control unit 1400 may be implemented with one or more processors executing a program for performing a pressure medium filling process.

The filling gun 1500 may include a plurality of connection pipes connected to the vacuum unit 1200 and the injection unit 1300. The filling gun 1500 may be connected to the brake system 100 of the vehicle 1 to supply pneumatic pressure thereto, apply vacuum pressure to discharge air from the internal fluid passages, and inject the pressure medium supplied from the injection unit 1300.

For example, the filling gun 1500 may apply pneumatic pressure through one of the connection pipes, suction air from the brake system 100 through another, and inject pressure medium through a separate one.

The pressure medium charging apparatus 1000 may apply vacuum to the brake system 100 to suction air from the fluid passages and, after a predetermined vacuum duration, inject the pressure medium into a reservoir 210 (described later) of the brake system 100. Through this process, the pressure medium charging apparatus 1000 may fill the fluid passages of the brake system 100 without leaving air voids.

During the vacuum process, the brake system 100 may control valves within the fluid passages to prevent air from being trapped. During the injection process, the brake system 100 may also control the valves to ensure the pressure medium fills the internal spaces completely without air gaps. Details of this process are described below.

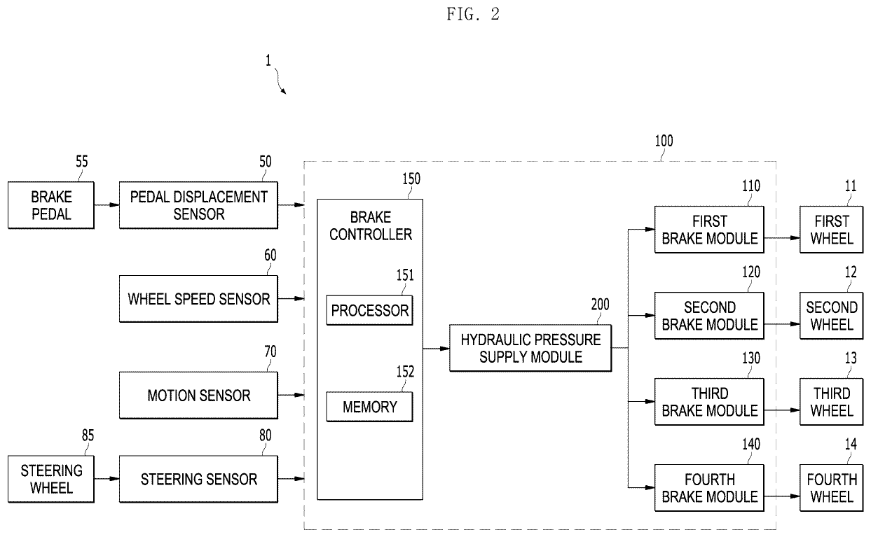

Referring to FIG. 2, a vehicle 1 may include a plurality of wheels 11, 12, 13, and 14 configured to rotate to allow movement of the vehicle, a brake pedal 55 configured to receive braking input from a driver, a pedal displacement sensor 50 configured to detect movement of the brake pedal 55, wheel speed sensors 60 respectively corresponding to the wheels and configured to detect rotational speeds of the wheels, a motion sensor 70 configured to detect movement of the vehicle 1, a steering sensor 80 configured to detect rotation of a steering wheel 85, and a brake system 100 configured to apply braking force to stop the vehicle 1.

The pedal displacement sensor 50, the wheel speed sensors 60, the motion sensor 70, and the steering sensor 80 are not essential components and may be omitted individually or in combination depending on the embodiment.

The wheels 11, 12, 13, and 14 may, for example, include a first wheel 11 positioned at the front-left side of the vehicle 1, a second wheel 12 at the front-right side, a third wheel 13 at the rear-left side, and/or a fourth wheel 14 at the rear-right side. However, the number of wheels is not limited to four.

The brake pedal 55 may be disposed in a lower portion of a cabin such that a driver can operate it with their foot. The driver may press the brake pedal 55 to indicate an intent to decelerate or stop the vehicle. The brake pedal 55 may move from a reference position in response to the driver's input.

The pedal displacement sensor 50 may be positioned adjacent to the brake pedal 55 and may measure the displacement of the brake pedal 55 caused by the driver's braking intention. For example, the sensor may detect a distance and/or speed of movement from the reference position.

The pedal displacement sensor 50 may be electrically connected to the brake system 100 and configured to provide electric signals thereto. For example, it may be directly connected via a hard-wired connection or communicatively connected via a network. The sensor may provide a signal corresponding to the displacement or speed of movement of the brake pedal 55. In some embodiments, the sensor may be integrated with the brake system 100.

The brake system 100 may include a plurality of brake modules 110, 120, 130, and 140 respectively installed on the wheels 11, 12, 13, and 14, and a brake controller 150 configured to perform braking control of the brake modules.

Each of the brake modules 110, 120, 130, and 140 may be configured to apply braking force to a corresponding wheel and thereby slow or stop the vehicle 1. For example, the first brake module 110 may correspond to the first wheel 11, the second brake module 120 to the second wheel 12, the third brake module 130 to the third wheel 13, and/or the fourth brake module 140 to the fourth wheel 14. The number of brake modules is not limited to four.

Each of the brake modules 110, 120, 130, and 140 may be configured as a hydraulic brake operated by hydraulic pressure to apply braking force to the wheels. In this regard, the brake system 100 may include a hydraulic pressure supply module 200 that provides hydraulic pressure to the brake modules through a hydraulic line HL.

Each of the brake modules 110, 120, 130, and 140 may be implemented as a hydraulic brake configured to be actuated by hydraulic pressure to apply braking force to the corresponding wheels 11, 12, 13, and 14. In this regard, the brake system 100 may include a hydraulic pressure supply module 200 configured to supply hydraulic pressure to the brake modules 110, 120, 130, and 140.

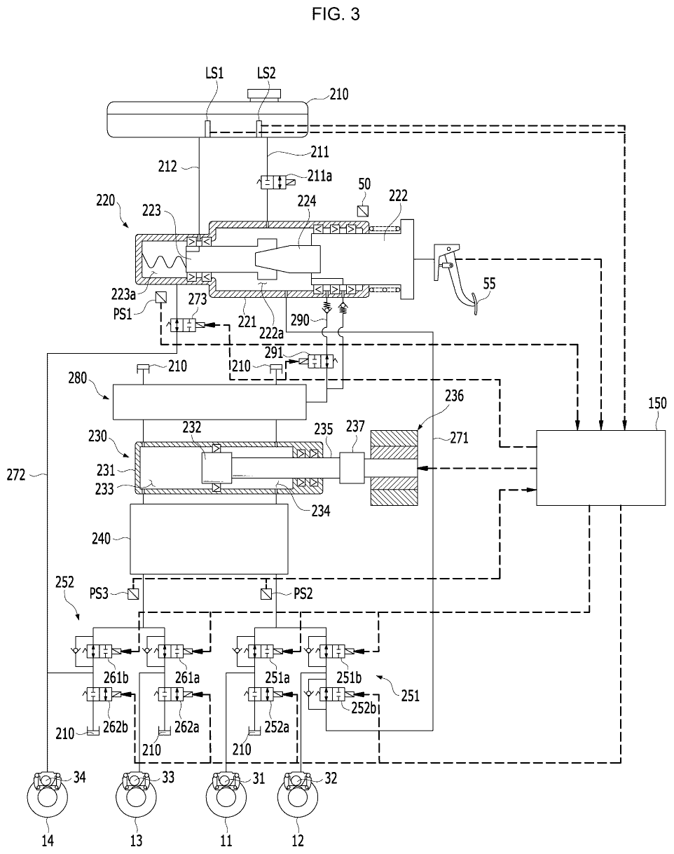

Referring to FIG. 3, a hydraulic pressure supply module 200 may generate hydraulic pressure for braking the first through fourth wheels 11, 12, 13, and 14, and may supply the generated hydraulic pressure to the first through fourth brake modules 110, 120, 130, and 140.

Specifically, the hydraulic pressure supply module 200 may include: a reservoir 210 configured to store a pressure medium; a master cylinder 220 configured to provide applied force corresponding to the driver's pedal force and to pressurize and discharge the pressure medium such as brake oil stored therein; a hydraulic pressure supply unit 230 configured to generate hydraulic pressure of the pressure medium based on an electrical signal corresponding to the displacement of a brake pedal 55 detected by a pedal displacement sensor 50; a hydraulic control unit 240 configured to control the hydraulic pressure provided from the hydraulic pressure supply unit 230; a hydraulic circuit 250 including wheel cylinders 31 and 32 configured to receive the hydraulic pressure and apply braking force to each of the wheels 11, 12, 13, and 14; a backup passage 271 hydraulically connecting the master cylinder 220 and the hydraulic circuit 250; a dump control unit 280 provided between the hydraulic pressure supply unit 230 and the reservoir 210 and configured to control the flow of the pressure medium; a reservoir passage 211, 212 hydraulically connecting the reservoir 210 and the master cylinder 220; and an inspection passage 290 connected to a master chamber of the master cylinder 220.

The reservoir 210, master cylinder 220, hydraulic pressure supply unit 230, hydraulic control unit 240, hydraulic circuit 250, backup passage 271, dump control unit 280, reservoir passage 211, 212, and inspection passage 290 are not necessarily essential components, and all or some of them may be omitted depending on the implementation.

The reservoir 210 may be configured to receive and/or store the pressure medium therein. The reservoir 210 may be connected to the master cylinder 220, the hydraulic pressure supply unit 230, and/or the hydraulic circuit 250 to supply or receive the pressure medium.

The reservoir passage 211, 212 may include a first reservoir passage 211 connecting a first master chamber 222a of the master cylinder 220 to the reservoir 210, and a second reservoir passage 212 connecting a second master chamber 223a of the master cylinder 220 to the reservoir 210. A simulator valve 211a may be provided in the first reservoir passage 211 to control the flow of the pressure medium between the reservoir 210 and the first master chamber 222a through the first reservoir passage 211.

The master cylinder 220 may provide an applied force corresponding to the pedal force applied by the driver to the brake pedal 55 and thus deliver a stable pedal feel to the driver. In addition, the master cylinder 220 may be configured to pressurize and discharge the pressure medium stored therein in response to the operation of the brake pedal 55.

The master cylinder 220 may include: a cylinder body 221 in which a chamber is formed; a first master chamber 222a formed at an inlet side of the cylinder body 221 where the brake pedal 55 is connected; a first master piston 222 disposed in the first master chamber 222a and configured to be displaceable by the operation of the brake pedal 55; a second master chamber 223a formed inside or on a forward side (left side in FIG. 3) of the first master chamber 222a within the cylinder body 221; a second master piston 223 disposed in the second master chamber 223a and configured to be displaceable by the displacement of the first master piston 222 or the hydraulic pressure of the pressure medium received in the first master chamber 222a; and a pedal simulator 224 disposed between the first and second master pistons 222 and 223 and configured to provide pedal feel to the driver through an elastic restoring force generated during compression.

The cylinder body 221, the first master chamber 222a, the first master piston 222, the second master chamber 223a, the second master piston 223, and the pedal simulator 224 are not necessarily essential components, and all or some of them may be omitted depending on the embodiment.

The first master piston 222 and the second master piston 223 may be respectively disposed in the first master chamber 222a and the second master chamber 223a, and may generate hydraulic pressure or negative pressure in the respective chambers by moving forward or backward.

The pedal simulator 224 may be disposed between the first master piston 222 and the second master piston 223, and may provide a pedal feel to the driver of the brake pedal 55 through its own elastic restoring force.

A hydraulic pressure supply unit 230 may be configured to generate hydraulic pressure of the pressure medium through mechanical operation based on an electrical signal received from the pedal displacement sensor 50, which detects displacement of the brake pedal 55 and represents the driver's braking intention.

The hydraulic pressure supply unit 230 may include: a cylinder block 231 configured to accommodate the pressure medium; a hydraulic piston 232 received in the cylinder block 231; pressure chambers 233 and 234 partitioned by the hydraulic piston 232 and the cylinder block 231; a hydraulic motor 236 configured to generate rotational force; a power conversion unit 237 configured to convert the rotational force of the hydraulic motor 236 into linear motion of the hydraulic piston 232; and a drive shaft 235 configured to transmit the driving force to the hydraulic piston 232.

The cylinder block 231, the hydraulic piston 232, the pressure chambers 233 and 234, the hydraulic motor 236, the power conversion unit 237, and the drive shaft 235 are not necessarily essential components of the hydraulic pressure supply unit 230, and all or some of them may be omitted depending on the implementation.

The pressure chambers 233 and 234 may include a first pressure chamber 233 located on a front side of the hydraulic piston 232 (i.e., the left side of the piston 232 in FIG. 3), and a second pressure chamber 234 located on a rear side of the hydraulic piston 232 (i.e., the right side in FIG. 3).

Specifically, the first pressure chamber 233 may be defined by the cylinder block 231 and a front surface of the hydraulic piston 232 such that its volume changes according to the movement of the hydraulic piston 232. Likewise, the second pressure chamber 234 may be defined by the cylinder block 231 and a rear surface of the hydraulic piston 232 such that its volume also changes according to the movement of the piston.

When the pedal displacement sensor 50 detects displacement of the brake pedal 55, the hydraulic piston 232 may move forward within the cylinder block 231, generating hydraulic pressure in the first pressure chamber 233 and generating negative pressure in the second pressure chamber 234.

Conversely, when the pedal force applied to the brake pedal 55 is released, the hydraulic piston 232 may move backward within the cylinder block 231, generating negative pressure in the first pressure chamber 233 and generating hydraulic pressure in the second pressure chamber 234.

In this way, the hydraulic pressure supply unit 230 may generate either hydraulic pressure or negative pressure in the first and second pressure chambers 233 and 234 by driving the hydraulic motor 236.

The hydraulic pressure supply unit 230 may be hydraulically connected to the reservoir 210 via a dump control unit 280. The dump control unit 280 may include at least one flow passage and at least one valve configured to control the flow of the pressure medium between the hydraulic pressure supply unit 230 and the reservoir 210.

The hydraulic control unit 240 may be configured to control the hydraulic pressure delivered to each of the wheel cylinders 31, 32, 33, and 34.

The hydraulic control unit 240 may be connected to first and second hydraulic circuits 251 and 252, which are configured to control the flow of hydraulic pressure delivered to the first through fourth wheel cylinders 31, 32, 33, and 34.

The hydraulic control unit 240 may include a plurality of flow paths and a plurality of valves configured to guide the hydraulic pressure supplied from the hydraulic pressure supply unit 230 to the first and second hydraulic circuits 251 and 252.

The hydraulic control unit 240 may form a flow path for delivering the pressure medium to the first and second hydraulic circuits 251 and 252 by utilizing the pressure generated in the first pressure chamber 233 when the hydraulic piston 232 moves forward. For example, the hydraulic control unit 240 may form a flow path connecting the first pressure chamber 233 to the first and second hydraulic circuits 251 and 252. The pressure medium of the first pressure chamber 233 may be delivered to the first and second hydraulic circuits 251 and 252 through the hydraulic control unit 240.

The hydraulic control unit 240 may also form a flow path for delivering the pressure medium to the first and second hydraulic circuits 251 and 252 by utilizing the pressure generated in the second pressure chamber 234 when the hydraulic piston 232 moves backward. For example, the hydraulic control unit 240 may form a flow path connecting the second pressure chamber 234 to the first and second hydraulic circuits 251 and 252. The pressure medium of the second pressure chamber 234 may be delivered to the first and second hydraulic circuits 251 and 252 through the hydraulic control unit 240.

The hydraulic control unit 240 may form flow paths for recovering the pressure medium from the first and second hydraulic circuits 251 and 252 by utilizing negative pressure generated in the first pressure chamber 233 when the hydraulic piston 232 moves backward. For example, the hydraulic control unit 240 may form flow paths connecting the first hydraulic circuit 251 to the first pressure chamber 233, and the second hydraulic circuit 252 to the first pressure chamber 233. The pressure medium in the first and second hydraulic circuits 251 and 252 may be returned to the first pressure chamber 233 through the hydraulic control unit 240.

The hydraulic control unit 240 may also form flow paths for recovering the pressure medium from the first and second hydraulic circuits 251 and 252 by utilizing negative pressure generated in the second pressure chamber 234 when the hydraulic piston 232 moves forward. For example, the hydraulic control unit 240 may form flow paths connecting the first hydraulic circuit 251 to the second pressure chamber 234, and the second hydraulic circuit 252 to the second pressure chamber 234. The pressure medium in the first and second hydraulic circuits 251 and 252 may be returned to the second pressure chamber 234 through the hydraulic control unit 240.

The first hydraulic circuit 251 may be configured to adjust and/or control the hydraulic pressure applied to the first and second wheel cylinders 31 and 32, and the second hydraulic circuit 252 may be configured to adjust and/or control the hydraulic pressure applied to the third and fourth wheel cylinders 33 and 34.

The first hydraulic circuit 251 may include first and second inlet valves 251a and 251b disposed upstream of the first and second wheel cylinders 31 and 32, respectively, and configured to control the flow and hydraulic pressure of the pressure medium supplied to the respective wheel cylinders. The first and second inlet valves 251a and 251b may be implemented as normally open-type solenoid valves.

The first hydraulic circuit 251 may further include first and second outlet valves 252a and 252b configured to control the flow of the pressure medium discharged from the first and second wheel cylinders 31 and 32, respectively, for improved performance during release of braking.

The first outlet valve 252a may be disposed on a discharge side of the first wheel cylinder 31 and may be configured to control the flow of the pressure medium discharged from the first wheel cylinder 31 toward the reservoir 210. The first outlet valve 252a may be implemented as a normally closed-type solenoid valve.

The second outlet valve 252b may be connected to (or provided in) a first backup passage 271 that corresponds to the discharge side of the second wheel cylinder 32, and may be configured to control the flow of the pressure medium between the second wheel cylinder 32 and the master cylinder 220. However, the connection structure of the first backup passage 271 is not limited thereto. For example, the first backup passage 271 may be connected to the first wheel cylinder 31. Alternatively, the first backup passage 271 may be connected to both the first and second wheel cylinders 31 and 32. In this way, the first backup passage 271 may be connected to at least one of the first and second wheel cylinders 31 and 32. The second outlet valve 252b may be implemented as a normally open-type solenoid valve.

The second hydraulic circuit 252 may include third and fourth inlet valves 261a and 261b respectively disposed upstream of the third and fourth wheel cylinders 33 and 34, and configured to control the flow and hydraulic pressure of the pressure medium delivered to the respective wheel cylinders. The third and fourth inlet valves 261a and 261b may be implemented as normally open-type solenoid valves.

The second hydraulic circuit 252 may further include third and fourth outlet valves 262a and 262b configured to control the flow of the pressure medium discharged from the third and fourth wheel cylinders 33 and 34, respectively, in order to enhance performance during release of braking.

The third outlet valve 262a may be provided on a discharge side of the third wheel cylinder 33 and may be configured to control the flow of the pressure medium discharged from the third wheel cylinder 33 toward the reservoir 210. The third outlet valve 262a may be implemented as a normally closed-type solenoid valve.

The fourth outlet valve 262b may be provided on a discharge side of the fourth wheel cylinder 34 and may be configured to control the flow of the pressure medium discharged from the fourth wheel cylinder 34 toward the reservoir 210. The fourth outlet valve 262b may also be implemented as a normally closed-type solenoid valve.

A second backup passage 272 may be provided on the discharge side of the fourth wheel cylinder 34. The second backup passage 272 may include a cut valve 273 configured to control the flow of the pressure medium between the fourth wheel cylinder 34 and the master cylinder 220.

However, the connection structure of the second backup passage 272 is not limited thereto. For example, the second backup passage 272 may be connected to the third wheel cylinder 33. Alternatively, the second backup passage 272 may be connected to both the third and fourth wheel cylinders 33 and 34. That is, the second backup passage 272 may be connected to at least one of the third and fourth wheel cylinders 33 and 34.

At least one of the first backup passage 271 and the second backup passage 272 may be configured to directly deliver hydraulic pressure from the master cylinder 220 to the respective wheel cylinders 31, 32, 33, and 34 in a fallback mode, such as when a failure or abnormal condition prevents the hydraulic pressure supply module 200 from operating normally.

For example, the first backup passage 271 may be configured to connect a first master chamber 222a of the master cylinder 220 to the first hydraulic circuit 251, and the second backup passage 272 may be configured to connect a second master chamber 223a of the master cylinder 220 to the second hydraulic circuit 252.

An inspection passage 290 may be provided to connect the master cylinder 220 and the dump control unit 280, and may be configured to inspect whether components mounted in the master cylinder 220, including the simulator valve 211a, are leaking.

The hydraulic pressure supply module 200 may include a first pressure sensor PS1 configured to detect the hydraulic pressure provided by the master cylinder 220, and second and third pressure sensors PS2 and PS3 configured to detect the hydraulic pressure of the pressure medium supplied by the hydraulic pressure supply unit 230.

The first pressure sensor PS1, the second pressure sensor PS2, and the third pressure sensor PS3 may output pressure detection signals as electrical signals representing the detected pressure. However, the positions of the pressure sensors PS1, PS2, and PS3 are not limited to those shown in FIG. 3 and may be provided at various positions to detect the hydraulic pressure of the pressure medium.

The hydraulic pressure supply module 200 may further include a first level sensor LS1 and a second level sensor LS2 configured to detect the fluid level of the pressure medium stored in the reservoir 210. The level sensors LS1 and LS2 may output level detection signals as electrical signals representing the detected fluid level.

Referring again to FIG. 1, the brake controller 150 may receive output signals from the pedal displacement sensor 50, the wheel speed sensors 60, the motion sensor 70, and/or the steering sensor 80, and may perform braking control of the plurality of brake modules 110, 120, 130, and 140.

The brake controller 150 may provide braking control signals to the plurality of brake modules 110, 120, 130, and 140 to decelerate the vehicle 1 based on an electrical signal output from the pedal displacement sensor 50. For example, the brake controller 150 may identify a braking force (or braking deceleration) corresponding to the driver's braking intent based on the output signal of the pedal displacement sensor 50, and may provide braking control signals to the brake modules 110, 120, 130, and 140 corresponding to the identified braking force (or deceleration).

The brake controller 150 may also be configured to distribute braking force among the plurality of brake modules 110, 120, 130, and 140 based on the electrical signal output from the pedal displacement sensor 50. For example, the brake controller 150 may distribute the requested braking force from the driver among the brake modules 110, 120, 130, and 140, and provide a respective braking control signal to each brake module in accordance with the distributed braking force. In this regard, the brake system 100 may include electronic brake force distribution (EBD).

The brake controller 150 may further provide braking control signals to the brake modules 110, 120, 130, and 140 to temporarily allow rotation of the wheels 11, 12, 13, and 14 based on electrical signals output from the wheel speed sensors 60. For example, during braking of the vehicle 1, the brake controller 150 may identify slip of one or more of the wheels 11, 12, 13, and 14 based on the wheel speed sensor signals. In response to the identified slip, the brake controller 150 may provide control signals to temporarily allow rotation of the slipping wheels to reduce or eliminate the slip condition. In this regard, the brake system 100 may include an anti-lock braking system (ABS).

The brake controller 150 may be configured to provide braking control signals to the plurality of brake modules 110, 120, 130, and 140 to temporarily brake the plurality of wheels 11, 12, 13, and 14 without the driver's braking intention, based on electrical signals output from the wheel speed sensors 60. For example, during vehicle travel, the brake controller 150 may identify spinning of the wheels 11, 12, 13, and 14 based on the output signals from the wheel speed sensors 60. In response to such wheel spin, the brake controller 150 may provide braking control signals to the brake modules 110, 120, 130, and 140 to temporarily brake the wheels to eliminate or reduce the spinning. In this regard, the brake system 100 may include a traction control system (TCS).

The brake controller 150 may further be configured to provide braking control signals to temporarily brake the plurality of wheels 11, 12, 13, and 14 without the driver's braking intention, based on electrical signals output from the motion sensor 70 and/or the steering sensor 80. For example, during steering of the vehicle 1, the brake controller 150 may identify a reference turning path of the vehicle based on the output signal of the steering sensor 80, and may identify an actual turning path of the vehicle based on the output signal of the motion sensor 70. The brake controller 150 may compare the reference path and the actual path to determine whether the vehicle is experiencing oversteering or understeering. In response to the detected oversteering and/or understeering, the brake controller 150 may provide braking control signals to the brake modules 110, 120, 130, and 140 to temporarily brake the wheels 11, 12, 13, and 14. In this regard, the brake system 100 may include an electronic stability control (ESC) system.

The brake controller 150 may also be configured to provide a parking signal to the plurality of brake modules 110, 120, 130, and 140 to prevent rotation of the wheels 11, 12, 13, and 14 in response to a parking command from the driver. In this regard, the brake system 100 may include an electronic parking brake (EPB) system.

The brake controller 150 may include at least one semiconductor device and may be referred to as a brake control unit (BCU), electronic control unit (ECU), or other similar terminology. For example, the brake controller 150 may include at least one processor and/or at least one memory. In one embodiment, the brake controller 150 may include a processor 151 and a memory 152.

The processor 151, memory 152, and other components described above are not necessarily essential components of the brake system 100, and all or some of them may be omitted depending on the implementation.

The brake controller 150 may further include a plurality of processors 151 in order to ensure reliable execution of predetermined functions and to provide fault tolerance in the event of damage or malfunction in the electrical system. For example, the brake controller 150 may include a first processor and a second processor. The second processor may be provided as a backup and is not an essential component and may be omitted depending on the implementation.

The processor 151 may be configured to provide control signals to control the operation of various components included in the brake system 100 according to the driver's braking intention.

The memory 152 may be configured to store or retain programs and data used to implement operations for controlling the components included in the brake system 100.

The memory 152 may provide the stored programs and data to the processor 151 and may temporarily store data generated during operation of the processor 151. For example, the memory 152 may include volatile memory such as static random access memory (SRAM) and dynamic random access memory (DRAM), and non-volatile memory such as read-only memory (ROM), erasable programmable read-only memory (EPROM), and flash memory.

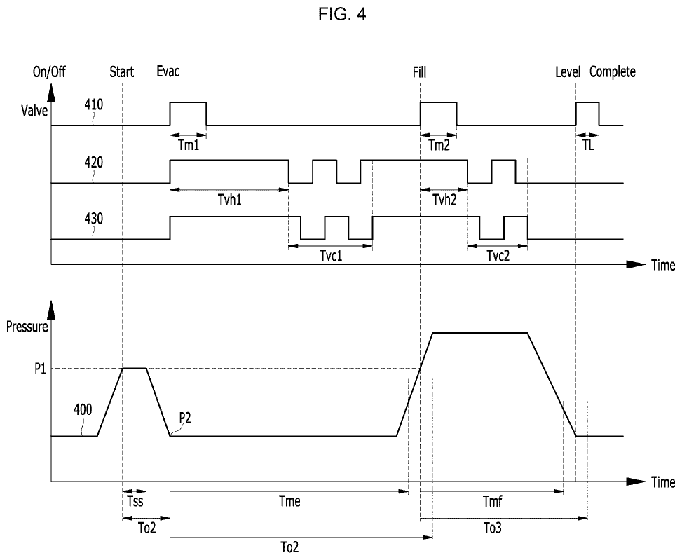

Referring to FIG. 4, the brake controller 150 may perform a filling control sequence related to a pressure medium. In this regard, the brake controller 150 may identify a start of the filling control sequence based on a variation in a pressure detection signal 400 from pressure sensors PS1, PS2, and PS3 during a standby mode. After identifying the start of the filling control sequence, the brake controller 150 may identify entry into a first operation mode based on the variation in the pressure detection signal 400, and further identify entry into a second operation mode from the first operation mode based on the pressure variation. The brake controller 150 may control at least one of the hydraulic pressure supply unit 230 and the hydraulic control unit 240 based on a predetermined control pattern in at least one of the first operation mode and the second operation mode.

More specifically, the brake controller 150 may enter a standby mode for executing the filling control sequence based on the presence of a standby flag set by at least one of the vehicle 1 and a user. For example, in response to an assembly process or maintenance process of the vehicle 1, the brake controller 150 may check whether a standby flag has been set by various controllers of the vehicle 1 or by the user, and enter the standby mode for performing the filling control sequence related to the pressure medium accordingly.

In the standby mode, the brake controller 150 may receive the pressure detection signal 400 output from the pressure sensors PS1, PS2, and PS3, and may extract a sensed pressure from the received signal. The brake controller 150 may detect a standby-mode pressure of about 0.5 bar from the pressure detection signal 400 during the standby mode.

The brake controller 150 may identify the start of the filling control sequence based on a variation in the pressure detection signal 400 during the standby mode. Here, the filling control sequence may refer to a control sequence performed by the brake controller 150 to fill the pressure medium into the hydraulic pressure supply module 200 of the brake system 100.

The brake controller 150 may detect a sensed pressure from the pressure detection signal 400 and compare the detected pressure with a predetermined first reference pressure P1. The first reference pressure P1 may be a pressure value configured to recognize the start of the filling control sequence. For example, the reference pressure P1 may be set to about 3 bar based on at least one of: calibration of the pressure sensors PS1, PS2, and PS3; a baseline pressure of the hydraulic pressure supply module 200; and a detection margin associated with the pressure detection signal 400.

The brake controller 150 may measure a detection duration during which a sensed pressure satisfies a first reference pressure P1, and may compare the measured detection duration with a predetermined maintenance reference time Tss. If the detection duration satisfies the maintenance reference time Tss, the brake controller 150 may identify the start of the filling control sequence. For example, the brake controller 150 may be configured to determine the start of the filling control sequence when the pressure medium charging apparatus 1000 applies pneumatic pressure for a time duration equal to or longer than the maintenance reference time Tss.

The maintenance reference time Tss may be a predetermined time value set to identify the start of the filling control sequence based on the sensitivity of the pressure sensors PS1, PS2, and PS3. For example, the maintenance reference time Tss may be set to about 500 ms, which corresponds to the time duration during which a sensed pressure is detected in response to pneumatic pressure applied to the reservoir 210 by the pressure medium charging apparatus 1000.

After identifying the start of the filling control sequence, the brake controller 150 may identify an entry into a first operation mode based on variations in the pressure detection signal 400. The first operation mode may correspond to an evacuation mode in which air within fluid passages of the hydraulic pressure supply module 200 in the brake system 100 is discharged.

In this case, the brake controller 150 may compare the sensed pressure detected from the pressure detection signal 400 with a second reference pressure P2 based on the variation in the signal. The second reference pressure P2 may be set to be equal to the standby-mode pressure detected from the pressure detection signal 400. For example, after identifying the start of the filling control sequence, if the sensed pressure drops and reaches the second reference pressure P2, the brake controller 150 may determine that the system has entered the first operation mode.

If the sensed pressure does not reach the second reference pressure P2 within a predetermined first operation mode identification reference time To1, the brake controller 150 may terminate the filling control sequence. For example, if the sensed pressure fails to satisfy the second reference pressure P2 within the first operation mode identification reference time To1, the brake controller 150 may determine that at least one of the pressure medium charging apparatus 1000 and the hydraulic pressure supply module 200 is in an abnormal state unsuitable for entering the first operation mode, and may terminate the filling control sequence accordingly.

In the first operation mode, the brake controller 150 may control at least one of the hydraulic pressure supply unit 230 and the hydraulic control unit 240 to discharge air from fluid passages, based on a predetermined first control pattern. In this context, the brake controller 150 may control the motor 236 of the hydraulic pressure supply unit 230 and the inlet valves 251a, 251b, 261a, and 261b and outlet valves 252a, 252b, 262a, and 262b of the hydraulic control unit 240 such that air in the fluid passages of the hydraulic pressure supply module 200 is discharged to the outside.

For example, the brake controller 150 may control the operation of the motor 236 of the hydraulic pressure supply unit 230 based on a first motor control timing Tm1 of a first timing signal 410. The brake controller 150 may also control the operation of the inlet valves 251a, 251b, 261a, and 261b of the hydraulic control unit 240 based on a first valve hold control timing Tvh1 of a second timing signal 420. Additionally, the brake controller 150 may control the operation of the outlet valves 252a, 252b, 262a, and 262b based on a first valve cycle control timing Tvc1 of a third timing signal 430.

The brake controller 150 may identify an entry into the second operation mode based on variation in the pressure detection signal 400 during the first operation mode. The second operation mode may correspond to a filling mode in which the pressure medium is filled into the fluid passages of the hydraulic pressure supply module 200 after air removal has been completed in the brake system 100.

In this case, the brake controller 150 may compare the sensed pressure detected from the pressure detection signal 400 with the first reference pressure P1. For example, when the sensed pressure increases and reaches the first reference pressure P1 in the first operation mode, the brake controller 150 may identify entry into the second operation mode.

If the sensed pressure does not reach the second reference pressure P2 within a predetermined second operation mode identification reference time To2, the brake controller 150 may terminate the filling control sequence. For example, if the sensed pressure fails to satisfy the second reference pressure P2 within the second operation mode identification reference time To2, which may be about 80 seconds, the brake controller 150 may determine that at least one of the pressure medium charging apparatus 1000 and the hydraulic pressure supply module 200 is in an abnormal state unsuitable for entering the second operation mode and may terminate the filling control sequence.

Additionally, the brake controller 150 may compare the time at which entry into the second operation mode is identified with a first operation mode maintenance time Tme to verify whether air has been properly discharged from the fluid passages. For example, if entry into the second operation mode is identified before the first operation mode maintenance time Tme, which may be set to at least about 40 seconds, the brake controller 150 may determine that at least one of the pressure medium charging apparatus 1000 and the hydraulic pressure supply module 200 is in an abnormal state unsuitable for proper filling, and may terminate the filling control sequence.

In the second operation mode, the brake controller 150 may control at least one of the hydraulic pressure supply unit 230 and the hydraulic control unit 240 to fill the fluid passages with the pressure medium based on a predetermined second control pattern. In this regard, the brake controller 150 may control the motor 236 of the hydraulic pressure supply unit 230 and the inlet valves 251a, 251b, 261a, and 261b and the outlet valves 252a, 252b, 262a, and 262b of the hydraulic control unit 240 so as to fill the fluid passages of the hydraulic pressure supply module 200 with the pressure medium.

For example, the brake controller 150 may control the operation of the motor 236 of the hydraulic pressure supply unit 230 based on a second motor control timing Tm2 of a first timing signal 410. The brake controller 150 may also control the operation of the inlet valves 251a, 251b, 261a, and 261b of the hydraulic control unit 240 based on a second valve hold control timing Tvh2 of a second timing signal 420. In addition, the brake controller 150 may control the operation of the outlet valves 252a, 252b, 262a, and 262b based on a second valve cycle control timing Tvc2 of a third timing signal 430.

The brake controller 150 may identify entry into a third operation mode based on variations in the pressure detection signal 400 during the second operation mode. In this case, the brake controller 150 may compare a sensed pressure, detected from the pressure detection signal 400 during the second operation mode, with the second reference pressure P2. For example, when the sensed pressure drops and reaches the second reference pressure P2 during the second operation mode, the brake controller 150 may identify entry into the third operation mode.

The brake controller 150 may compare the end time of the second operation mode with a predetermined second operation mode maintenance time Tmf to determine whether the pressure medium has been properly filled into the fluid passages. Based on the comparison result, the brake controller 150 may either terminate the filling control sequence or re-perform the filling of the pressure medium in the second operation mode. For example, if the end of the second operation mode is identified before the second operation mode maintenance time Tmf, which may be set to at least about 20 seconds, the brake controller 150 may determine that at least one of the pressure medium charging apparatus 1000 and the hydraulic pressure supply module 200 is in an abnormal state that is unsuitable for transitioning to the third operation mode, and may accordingly terminate the filling control sequence or re-execute the filling in the second operation mode.

Furthermore, if the sensed pressure does not reach the second reference pressure P2 within a predetermined third operation mode identification reference time To3, the brake controller 150 may terminate the filling control sequence.

In the third operation mode, the brake controller 150 may adjust the fluid level of the pressure medium stored in the reservoir 210. For example, the brake controller 150 may control the hydraulic pressure supply unit 230 based on a predetermined third control pattern so as to adjust the fluid level in the reservoir 210. The brake controller 150 may control the operation of the motor 236 of the hydraulic pressure supply unit 230 based on a third leveling timing TL of a first timing signal 410.

Meanwhile, the brake controller 150 may repeatedly enter the second operation mode and perform the filling control sequence based on a predetermined number of sequence cycles. In this regard, the brake controller 150 may set an idling time after the end of the second operation mode in each cycle, and may re-enter the second operation mode based on the vacuum level separately measured during the idling time.

Additionally, the brake controller 150 may variably set the second operation mode maintenance time Tmf for each cycle. For example, the brake controller 150 may set a first maintenance time as the second operation mode maintenance time Tmf in the first cycle, and a second maintenance time shorter than the first maintenance time as the second operation mode maintenance time Tmf in the second cycle. Since most of the flow path is filled with the pressure medium in the second operation mode of the first cycle and the remaining part of the flow path is filled with the pressure medium in the second operation mode of the second cycle, the second operation mode maintenance time Tmf of the second cycle may be set shorter than the second operation mode maintenance time Tmf of the first cycle.

Moreover, the brake controller 150 may enter a leak check operation mode after the first operation mode to inspect for leakage in the fluid passages. In this regard, the leak check operation mode may be an operation mode in which the vacuum level is checked while maintaining vacuum in the first operation mode to determine whether any leakage is present in the fluid passages.

The brake controller 150 may check the vacuum level based on the pressure detection signal 400, or may receive a vacuum-level check signal from an external device and determine the vacuum level accordingly.

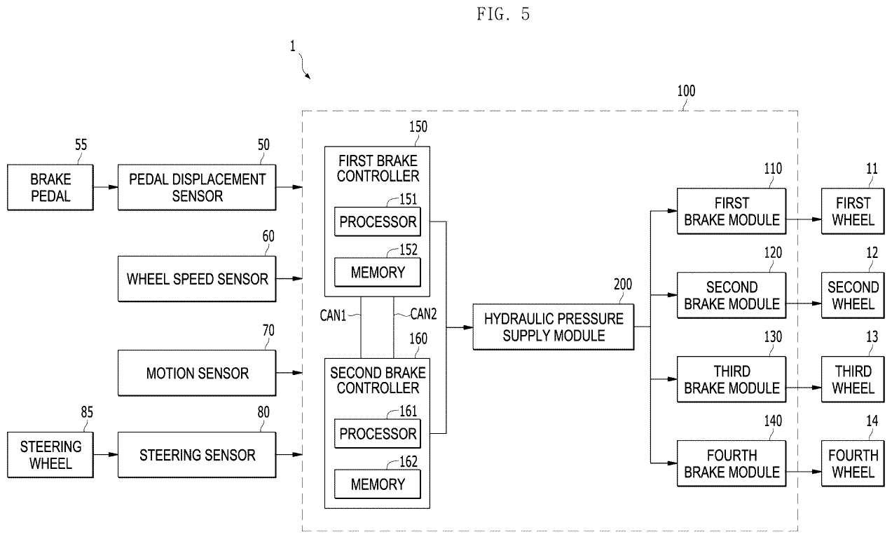

FIG. 5 illustrates another embodiment of a brake system according to one or more aspects of the present disclosure. In the following description, the focus will be placed on the first and second brake controllers.

Referring to FIG. 5, the brake controller 150, 160 may include a plurality of processors 151, 152 to ensure stable performance of designated functions and to provide redundancy in the event of electrical system damage and/or malfunction. For example, the brake controller 150, 160 may include a first brake controller 150 and a second brake controller 160. The second brake controller 160 may be provided as a backup, and is not an essential component, and may be omitted depending on the embodiment.

The first brake controller 150 and the second brake controller 160 may include a plurality of semiconductor devices, and may be referred to by various names, such as a brake control unit (BCU), electronic control unit (ECU), or similar terminology. The first and second brake controllers 150 and 160 may each include a plurality of processors and/or a plurality of memories. For example, the first brake controller 150 may include a processor 151 and a memory 152, and the second brake controller 160 may include a processor 161 and a memory 162. These components are not necessarily essential components of the brake system 100, and all or some of them may be omitted depending on the implementation.

The first brake controller 150 may perform predetermined computations based on output signals from the pedal displacement sensor 50 and/or the wheel speed sensor 60. Based on the results of the computations, the first brake controller 150 may identify a braking force (or braking deceleration or clamping force) corresponding to control functions such as service braking, electronic brakeforce distribution (EBD), anti-lock braking system (ABS), traction control system (TCS), electronic stability control (ESC), and electronic parking brake (EPB). The first brake controller 150 may output braking control signals corresponding to the identified braking force to all or some of the brake modules 110, 120, 130, and 140.

The first brake controller 150 and the second brake controller 160 may be connected via a first internal communication network (CAN1) to transmit and receive signals for identifying each other's operating status. Additionally, the first brake controller 150 and the second brake controller 160 may also be connected via a second internal communication network (CAN2) to transmit and receive signals for monitoring each other's status.

In this manner, the first brake controller 150 and the second brake controller 160 may be connected through redundant internal communication networks (CAN1 and CAN2), such that even if a failure occurs in one of the internal communication networks, the controllers may still monitor each other's status through the remaining normal communication network.

The first internal communication network (CAN1) and the second internal communication network (CAN2) may use various communication protocols including, for example, Ethernet, MOST (Media Oriented Systems Transport), UART (Universal Asynchronous Receiver/Transmitter), FlexRay, CAN (Controller Area Network), or LIN (Local Interconnect Network).

The first brake controller 150 may periodically transmit a status signal to the second brake controller 160. Based on reception of the periodic status signal from the first brake controller 150, the second brake controller 160 may determine that the first brake controller 150 is operating normally.

If the first brake controller 150 is not operating normally, it may fail to transmit the periodic status signal to the second brake controller 160. In such a case, the second brake controller 160 may determine that the first brake controller 150 is in an abnormal operating state (e.g., fault, error, reset, or power-off) based on failure to receive the periodic status signal within a predetermined cycle.

The second brake controller 160 may perform predetermined computations based on output signals from the pedal displacement sensor 50, the wheel speed sensor 60, the motion sensor 70, and/or the steering sensor 80. Based on the results of the computations, the second brake controller 160 may identify braking force corresponding to control functions such as service braking or EPB.

The first brake controller 150 may monitor the operation mode states of a filling control sequence based on pressure detection signals from the pressure sensors PS1, PS2, and PS3, and may transmit the monitored operation mode states to the second brake controller 160 using at least one of the first and second internal communication networks (CAN1, CAN2).

The second brake controller 160 may verify the operating state of the first brake controller 150 and, based on the verified state, may perform control of a designated operation mode within the filling control sequence.

Accordingly, in one aspect of the present disclosure, the brake system may ensure redundancy in response to failure of a controller responsible for performing a filling control sequence related to the pressure medium, thereby preventing cost increases and additional processing steps that may otherwise be required for applying external backup devices.

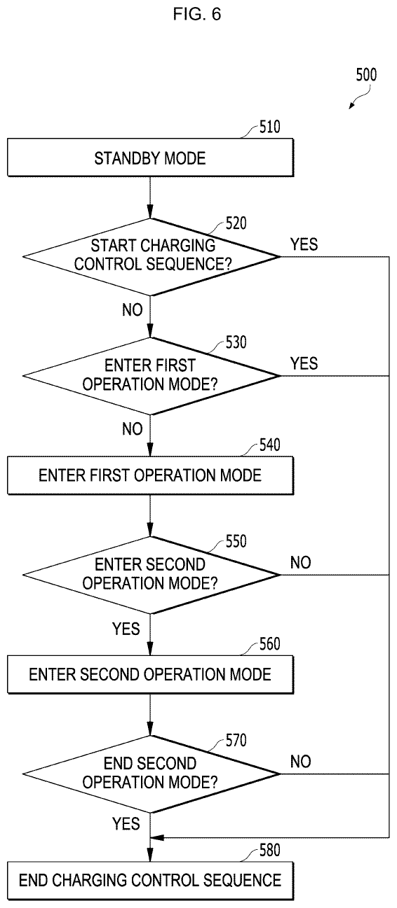

FIG. 6 illustrates a control method of a brake system according to one or more aspects of the present disclosure. In the following description, the control method will be described with reference to the previously described brake system.

Referring to FIG. 6, in a control method 500 of the brake system according to an aspect of the present disclosure, the brake controller 150 may identify the start of a filling control sequence related to a pressure medium based on variation in a pressure detection signal during a standby mode (510, 520). The brake controller 150 may detect a sensed pressure from the pressure detection signal, compare the detected pressure with a predetermined first reference pressure, and identify the start of the filling control sequence based on the comparison result.

Next, the brake controller 150 may identify entry into a first operation mode based on variation in the pressure detection signal after identifying the start of the filling control sequence (530).

Then, in the first operation mode, the brake controller 150 may control at least one of the hydraulic pressure supply unit 230 and the hydraulic control unit 240 to discharge air from the fluid passages based on a predetermined first control pattern (540).

Next, the brake controller 150 may identify entry into a second operation mode based on variation in the pressure detection signal during the first operation mode (550).

In the second operation mode, the brake controller 150 may control at least one of the hydraulic pressure supply unit 230 and the hydraulic control unit 240 to fill the fluid passages with the pressure medium based on a predetermined second control pattern (560).

The brake controller 150 may then identify the end of the second operation mode (570).

Finally, the brake controller 150 may terminate the filling control sequence (580).

According to one aspect of the present disclosure, it is possible to detect pressure variations that occur during air discharge and pressure medium filling processes by using a sensor of the brake actuator, and to control the hydraulic pressure supply unit and the hydraulic control unit based on the detected pressure.

Although the example embodiments have been described in detail, it should be understood that various changes, substitutions and alterations can be made herein without departing from the spirit and scope of the present disclosure as defined by the appended claims.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A brake system comprising:
a reservoir configured to store a pressure medium;
a master cylinder configured to pressurize and discharge the pressure medium stored in the reservoir based on an applied force of a brake pedal;
a hydraulic pressure supply unit configured to generate hydraulic pressure based on a pedal displacement signal output in response to displacement of the brake pedal;
a hydraulic control unit provided between the hydraulic pressure supply unit and a plurality of wheel cylinders, and configured to control a flow of the pressure medium supplied to the plurality of wheel cylinders;
at least one pressure sensor provided in a fluid passage connected to at least one of the reservoir, the master cylinder, the hydraulic pressure supply unit, and the hydraulic control unit, and configured to detect a hydraulic pressure of the pressure medium and output a pressure detection signal; and
a controller configured to control the hydraulic pressure supply unit and the hydraulic control unit,
wherein the controller is configured to:
identify a start of a filling control sequence related to the pressure medium based on the pressure detection signal rising above and being maintained at a predetermined first reference pressure during a standby mode,
identify entry into an air evacuation mode based on the pressure detection signal falling below a predetermined second reference pressure after identifying the start of the filling control sequence,
identify entry into a fluid filling mode based on the pressure detection signal rising again during the air evacuation mode,
control valves of the hydraulic control unit to repeatedly open and close during the air evacuation mode; and
control a motor of the hydraulic pressure supply unit to supply the pressure medium during fluid filling mode.

2. The brake system of claim 1, wherein the first reference pressure is set based on at least one of calibration of the pressure sensor, a baseline pressure of the fluid passage, or a detection margin associated with the pressure detection signal.

3. The brake system of claim 1, wherein the controller is configured to drive the motor of the hydraulic pressure supply unit based on a predetermined timing signal during the air evacuation mode while controlling operation of valves of the hydraulic control unit to discharge air from the fluid passage.

4. The brake system of claim 1, wherein the controller is configured to drive the motor of the hydraulic pressure supply unit based on a predetermined timing signal during the fluid filling mode while controlling operation of valves of the hydraulic control unit to fill the fluid passage with the pressure medium.

5. The brake system of claim 1, wherein the controller is configured to:
identify entry into a fluid level adjustment mode based on the pressure detection signal reaching the second reference pressure during the fluid filling mode, and
control the hydraulic pressure supply unit to adjust a fluid level of the pressure medium stored in the reservoir during the fluid level adjustment mode.

6. The brake system of claim 1, wherein the controller is configured to:
repeatedly perform a sequence comprising the air evacuation mode and the fluid filling mode for a predetermined number of times, and
set different maintenance times for the fluid filling mode during repetition of the sequence.

7. The brake system of claim 1, wherein the controller is configured to:
measure a detection time during which the pressure detection signal satisfies the first reference pressure,
compare the measured detection time with a maintenance reference time, and
identify the start of the filling control sequence based on the result of the comparison.

8. The brake system of claim 7, wherein the controller is configured to set the maintenance reference time based on a sensitivity of the pressure sensor to recognize the start of the filling control sequence.

9. The brake system of claim 1, wherein the second reference pressure is set to a sensed pressure detected from the pressure detection signal during the standby mode.

10. The brake system of claim 3, wherein the timing signal comprises control timing configured to control at least one of the motor of the hydraulic pressure supply unit and valves of the hydraulic control unit to discharge air from the fluid passage.

11. The brake system of claim 4, wherein the timing signal comprises control timing configured to control at least one of the motor of the hydraulic pressure supply unit and valves of the hydraulic control unit to fill the fluid passage with the pressure medium.

12. A control method for a brake system comprising a reservoir configured to store a pressure medium, a master cylinder configured to pressurize and discharge the pressure medium, a hydraulic pressure supply unit configured to generate hydraulic pressure, a hydraulic control unit configured to control the flow of the pressure medium, at least one pressure sensor provided in a fluid passage connected to at least one of the foregoing components and configured to detect a hydraulic pressure of the pressure medium and output a pressure detection signal, and a controller configured to control the hydraulic pressure supply unit and the hydraulic control unit, the method comprising:
identifying, by the controller, a start of a filling control sequence related to the pressure medium based on the pressure detection signal rising above and being maintained at a predetermined first reference pressure during a standby mode;
identifying entry into an air evacuation mode based on the pressure detection signal falling below a predetermined second reference pressure after identifying the start of the filling control sequence;
identifying entry into a fluid filling mode based on the pressure detection signal rising again during the air evacuation mode; and
controlling valves of the hydraulic control unit to repeatedly open and close during the air evacuation mode, and controlling a motor of the hydraulic pressure supply unit to supply the pressure medium during the fluid filling mode.

13. The control method of claim 12, further comprising setting the first reference pressure based on at least one of calibration of the pressure sensor, a baseline pressure of the fluid passage, or a detection margin associated with the pressure detection signal.

14. The control method of claim 12, further comprising the controller measuring a detection time during which the pressure detection signal satisfies the first reference pressure, comparing the measured detection time with a maintenance reference time, and identifying the start of the filling control sequence based on a result of the comparison.

15. The control method of claim 12, further comprising setting the second reference pressure to a sensed pressure detected from the pressure detection signal during the standby mode.

16. The control method of claim 12, further comprising the controller driving the motor of the hydraulic pressure supply unit based on a predetermined control timing during the air evacuation mode while controlling operation of valves of the hydraulic control unit to discharge air from the fluid passage.

17. The control method of claim 12, further comprising the controller driving the motor of the hydraulic pressure supply unit based on a predetermined control timing during the fluid filling mode while controlling operation of valves of the hydraulic control unit to fill the fluid passage with the pressure medium.

18. The control method of claim 12, further comprising the controller identifying entry into a fluid level adjustment mode based on the pressure detection signal reaching the second reference pressure during the fluid filling mode, and controlling the hydraulic pressure supply unit to adjust a fluid level of the pressure medium stored in the reservoir during the fluid level adjustment mode.

19. The control method of claim 12, further comprising the controller repeatedly performing a sequence comprising the air evacuation mode and the fluid filling mode for a predetermined number of times.

20. The control method of claim 19, further comprising the controller setting different maintenance times for the fluid filling mode during repetition of the sequence.
